(19) United States
(12) Patent Application Publication
(10) Pub. No.: US 2025/0091252 A1
(43) Pub. Date: Mar. 20, 2025

(54) APPARATUS TO IMPROVE THE HYDRODYNAMICS IN AN UNDERWATER PELLETIZER AND SYSTEM THEREOF

(71) Applicant: Braskem S.A., Camaçari (BR)

(72) Inventors: Thiago Roberto Almeida, São Paulo (BR); Alexandre Feoli Anele, São Paulo City (BR); Kevin Richard Soucy, Philadelphia, PA (US); Adam Jeffrey Bogardus, Philadelphia, PA (US); Michael A. Marando, Philadelphia, PA (US)

(73) Assignee: Braskem S.A., Camaçari (BR)

(21) Appl. No.: 18/890,362

(22) Filed: Sep. 19, 2024

Related U.S. Application Data
(60) Provisional application No. 63/539,166, filed on Sep. 19, 2023.

(51) Int. Cl. B29B 9/06

(52) U.S. Cl. CPC B29B 9/065

(57) ABSTRACT

An apparatus to improve the hydrodynamics in an underwater pelletizer, without the need of any modification of the current design or geometry of the pelletizer. The apparatus according to the present invention is designed under specific conditions and parameters, that improve the hydrodynamics in an underwater pelletizer, working as a diffuser. The present invention is additionally related to a system for improving hydrodynamics in an underwater pelletizer.

### BACKGROUND

Pelletizing is a widely known and broadly used operation in the industrial polyolefins field. This type of operation deals with mechanical properties of various polymer materials. The molten plastic is then passed through a die, which produces pellets. These pellets can be reused as raw material in manufacturing plants, thereby reducing raw material costs.

Such pelletizing operation is performed by means of pelletizing systems, which count on specific pelletizer equipment. Pelletizers are essential stage in polymer resin manufacture and their use is widely known.

The pellets produced in the available systems differ widely in shape, consistency, flow properties, and generation of dust and fines. These properties substantially affect pellet performance in material-handling systems downstream of the pelletizing process. The properties of the produced pellets depend, in addition to their own compositions (including molecular weight and density), on many factors, such as temperature, pressure, flow behavior, dosage, heat and cooling fluid flow.

Three major types of pelletizing systems are available, each with a distinctly different range of strengths and weaknesses. One of them is the underwater pelletizer, which is a die-face pelletizer and functions in such a manner that molten polymer is cut into pellets as it exits the die holes, which are arranged in a circular pattern in a round die.

In underwater pelletizers, different factors in the process can impact the pellet quality and the good operability. Coming from a previous stage, under very high temperature and pressure conditions, molten thermoplastic is forced to pass through a die with several holes of a circular profile. When the molten thermoplastic passes through the die holes it is cut by a set of knives attached to a rotatory piece (named knives-holder). Immediately, the pellets get in contact with water and then solidify. After, water and pellets are conveyed to a drier, where the pellets are separated from the water stream. Generally, the water is pumped back to the pelletizer chamber, in a close circuit.

Poor water hydrodynamics in the interface between the die and the knives-holder front face (where the set of knives are attached) leads to improper pellet formation and insufficient temperature drop to ensure the pellet solidification and its proper shape, causing it to stick to the knives, to the knives-holder or to each other's, forming agglomerates and/or die holes plug as potential fines generation. Such issues, consequently, lead to maintenance stops and/or equipment breakdown.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to an apparatus to improve the hydrodynamics in an underwater pelletizer, the apparatus being attachable to a knives-holder shaft support of the pelletizer or to an internal wall of the pelletizer chamber.

The apparatus according to the present invention comprises a tube extending from a first end to a second end along which a fluid flows, the first end being in fluid communication with a fluid supply from which the fluid flows in direction to the second end, and a main body in fluid communication with the second end. The main body has a first face and a second face parallel to the first face, spaced from each other by a lateral surface, the first face being integral and opposite to a die of the pelletizer, and the second face being hollow and facing a back side of the knives-holder; wherein the main body is designed to receive fluid from the second end of the tube and to deliver it towards the back side of the knives-holder by the second face.

In another aspect, embodiments disclosed herein relate to a system for improving hydrodynamics in an underwater pelletizer, the system comprising an apparatus attached to an underwater pelletizer by means of a knives-holder shaft support of such pelletizer or to an internal wall of the pelletizer chamber.

Such apparatus comprises a tube extending from a first end to a second end along which a fluid flows, the first end being in fluid communication with a pelletizer chamber inlet from which the fluid flows in direction to the second end, and a main body in fluid communication with the second end. The main body has a first face and a second face parallel to the first face, spaced from each other by a lateral surface, the first face being integral and opposite to a back side of the knives-holder of such pelletizer, the knives holder optionally having at least a pumping hole; and the second face being hollow and facing the back side of the knives-holder. The main body being designed to receive fluid from the second end of the tube and to deliver it towards the back side of the knives-holder by the second face; wherein the apparatus is in fluid communication with the die, so that the fluid leaves said apparatus and continuously contacts said die (and the knives holder back side) during pellets formation.

Other aspects and advantages of the claimed subject matter will be apparent from the following description, and the appended drawings and claims.

### BRIEF DESCRIPTION OF DRAWINGS

The present invention is described in connection with the attached FIGS. 1-6.

FIG. 1A shows a front isometric view of the apparatus according to one or more embodiments of the present invention.

FIG. 1B shows a back isometric view of the apparatus according to one or more embodiments of the present invention.

FIG. 2A shows the apparatus according to one or more embodiments of the present invention comprising a knives holder with pumping holes.

FIG. 2B shows the front view of the apparatus according to one or more embodiments of the present invention comprising a knives holder with pumping holes.

FIG. 2C shows the front view of the apparatus according to one or more embodiments of the present invention comprising a knives holder with pumping holes and depicts a distance “t” between the center of knives-holder and the center of the pumping hole and a distance “w”, which is the radius of the pumping role cross-section.

FIG. 3A shows the apparatus according to one or more embodiments of the present invention comprising a knives holder without pumping holes.

FIG. 3B shows the front view of the apparatus according to one or more embodiments of the present invention comprising a knives holder without pumping holes.

FIG. 4 shows a schematic view of the system according to one or more embodiments of the present invention.

FIG. 5 is a graphic illustration showing an amount of water coming from a pelletizer chamber inlet (PCW) that is captured by the apparatus according to the present invention (DFW/PCW), and the amount of water passing through the pumping holes (PHW/PCW).

FIG. 6 is a graphic illustrating the water residence time inside a pelletizer chamber (horizontal and transversal directions) and, especially, in the cutting and rotational regions.

### DETAILED DESCRIPTION

Embodiments disclosed herein are directed to an apparatus to improve the hydrodynamics in an underwater pelletizer and to a system thereof.

The present invention is related to an apparatus to improve the hydrodynamics in an underwater pelletizer, without requiring substantial modifications of the current design or geometry of the pelletizer. The apparatus according to the present invention is designed under specific conditions and parameters, that improve the hydrodynamics in an underwater pelletizer, working as a diffuser.

The present invention is additionally related to a system for improving hydrodynamics in an underwater pelletizer, the system comprising an apparatus according to the present invention attached to an underwater pelletizer and in fluid communication with it.

The apparatus according to the present invention is advantageously attachable to a pelletizer, by means of to a knives-holder shaft support of the pelletizer or to an internal wall of the pelletizer chamber. Due to this feature, the apparatus does not require substantial adaptations and modifications in pelletizers' designs, so that it can be used with a plurality of pelletizers.

By “attachable to” it is understood that the apparatus can be fixed, engaged, or mounted to pelletizers by means of at least one among screws, flanges, clips, but not limited to them.

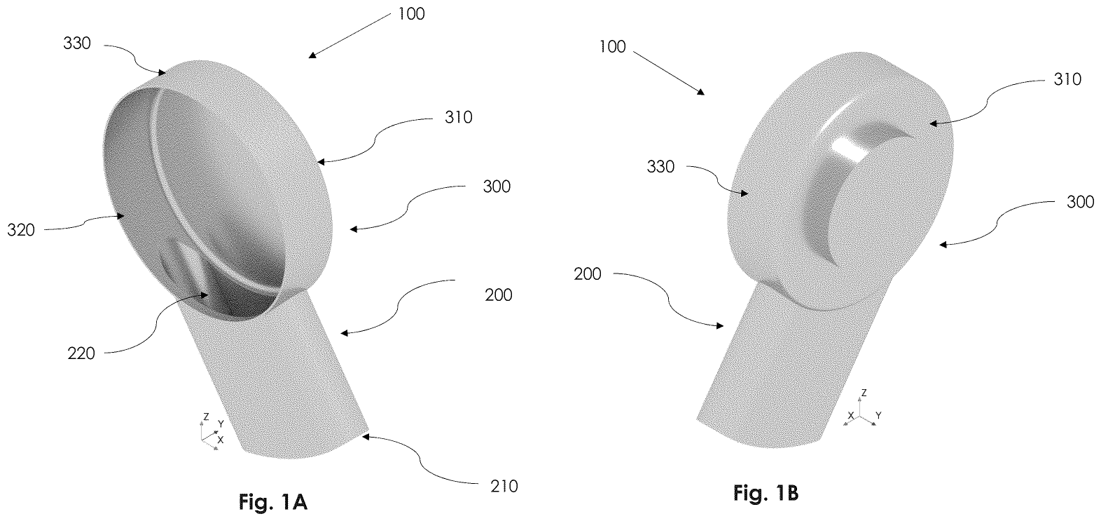

Referring to FIGS. 1A and 1B, a front and a back isometric views of the apparatus 100 according to one or more embodiments of the present invention are illustrated. According to one or more embodiments, the apparatus comprises a tube 200 extending from a first end 210 to a second end 220. When duly in operation, a fluid flows along the tube 200, from the first end 210 to the second end 220. For that, the first end 210 is in fluid communication with a fluid supply from which the fluid flows in a direction from the first end 210 to the second end 220.

Furthermore, the apparatus 100 comprises a main body 300 in fluid communication with the second end 220 of the tube 200. The main body 300 has a first face 310 and a second face 320, which is parallel to the first face 310, both the first and the second faces are spaced from each other by a lateral surface 330. The first face 310 is integral and opposite to a die of the pelletizer, and the second face 320 is hollow and faces a back side of the knives-holder. The main body 300 is designed to receive fluid from the second 220 end of the tube 200 and to deliver it towards the back side of the knives-holder by the second face 320.

According to one embodiment of the present invention, the main body 300 is cylindrical.

Still according to one embodiment of the present invention, at least one lateral surface of the tube 200 is tangential to the lateral surface 330 of the main body 300, and the main body 300 is designed to receive fluid from the second end 220 of the tube 200 and flow it in the same direction as a direction that the knives-holder runs. Accordingly, fluid enters tangentially in the main body 300, from the second end 220 of the tube 200, and flows within the main body in the same direction as a direction that the knives-holder runs, in a Reynolds number range from 1.0E+06 to 9E+07, preferably from 7.0E+06 to 2.0E+07. To calculate the Reynolds number, the characteristic diameter of the pelletizing chamber is used, as well as the average velocity of the fluid inside the chamber. The range of the fluid density is between 950 and 1050 kg/m³ and the dynamic viscosity is between 0.8 and 1 cP.

By “fluid” it is understood any fluid that can be used in processing and operations, or mixtures thereof. Preferably, the fluid is liquid; more preferably, the liquid is water or water based.

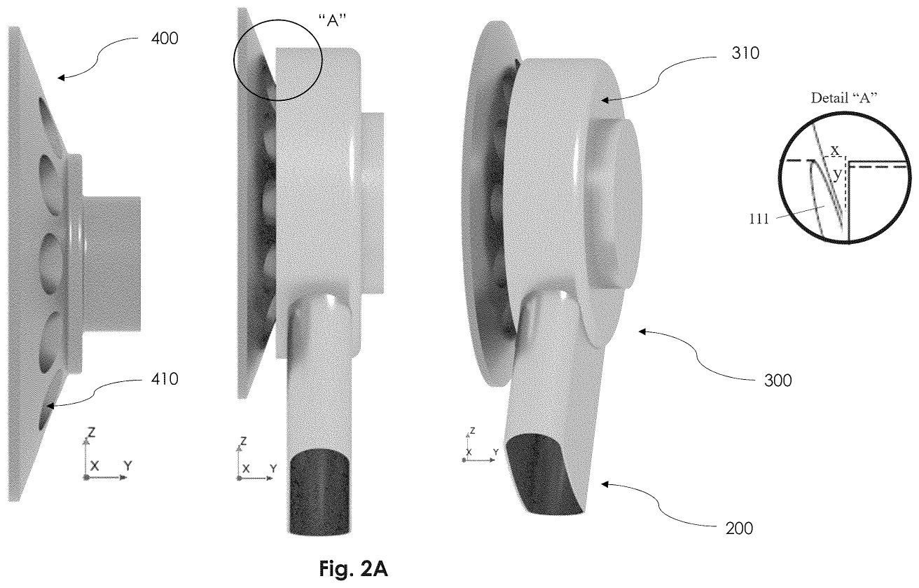

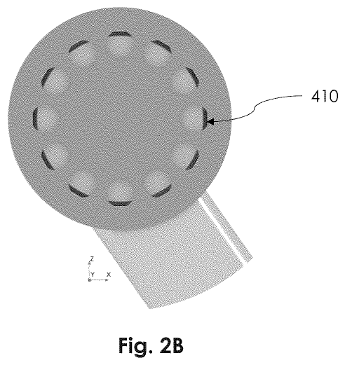

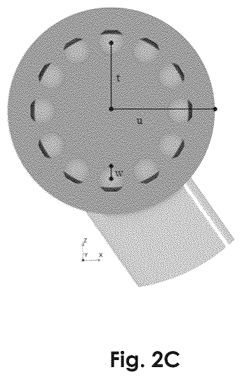

Referring to FIGS. 2A and 2B, examples of the apparatus 100 of the present invention positioned against the back side of a knives-holder 400 with pumping holes 410 are illustrated. As positioned, the fluid flowing from the first to the second ends of the tube 200 enters the main body 300 and deliver the fluid towards the back side 400 of the knives-holder by the second face 320, which is hollow and allow the fluid to leave the apparatus towards the die plate of the pelletizer.

In more detail, FIG. 2C depicts a distance “t” between the center of knives-holder and the center of the pumping hole, a distance “w”, which is the radius of the pumping role cross-section, and a distance “u”, which is the radius of the knives-holder.

In this regard, “Detail “A” depicts the positioning configuration of the second face 320 of the main body 300 in relation to the back face of the knives-holder 400 and its pumping holes 410. Accordingly, a horizontal distance “x” between the apparatus 100 and the knives-holder back face 400 and a vertical distance “y” between the main body's outer radius and the knives-holder back face 400 must be respected, when attaching the apparatus of the present invention to a pelletizer, in order to optimize the apparatus performance. The horizontal distance “x” is less than 45% of the radius of the main body 300, preferably between 2% and 25% of the radius of the main body 300; the vertical distance “y” satisfies the relationship:

t−w≤y≤u

wherein “t” is the distance the center of knives-holder and the center of the pumping hole, “w” is the radius of the pumping role cross-section, and “u” is the radius of the knives-holder.

In a preferred embodiment, the vertical distance y=u.

In an embodiment in which the knives holder comprises pumping holes 410, an external radius of the main body is preferably coincident to an external radius of the pumping holes (as depicted by the horizontal dashed lined in “Detail A” of FIG. 2A), and may vary by 10%, for more or for less, in relation to the radius of the main body 300. External radius should be interpreted as the external edge of the second face 320 of the main body 300 of the apparatus 100 according to the present invention. As per this embodiment, the pumping holes 410 are completely disposed within the area of the second face 320 of the main body 300 of the apparatus 100.

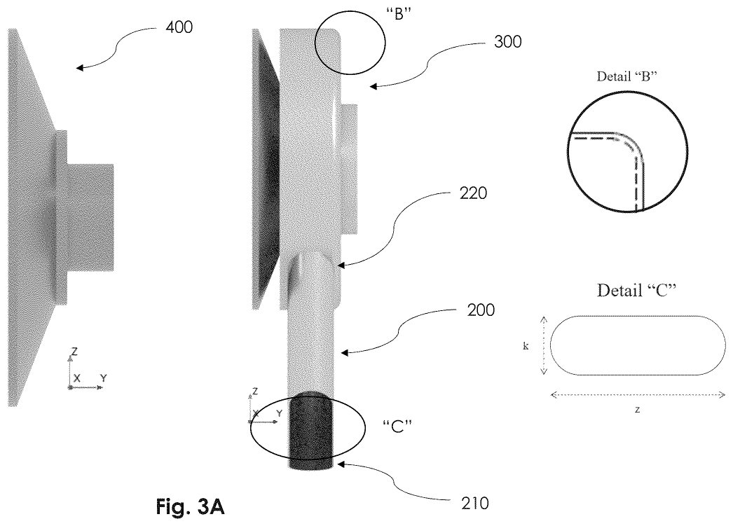

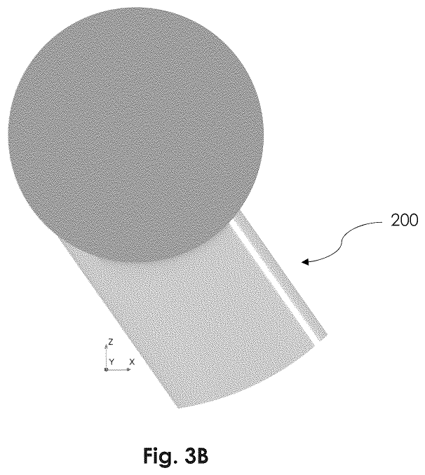

Referring to FIGS. 3A and 3B, examples of the apparatus 100 of the present invention positioned against the back side of a knives-holder 400 without pumping holes are illustrated. In such an embodiment, in which the knives-holder does not have pumping-holes, in which the knives holder does not comprise pumping holes, the external radius of the main body is equal or greater than the external radius of the knives-holder.

“Detail B” depicts the preferred shape of the vertexes of the main body, which are preferably round-shaped. Preferably, the radius of the round-shaped vertexes is less than 45% of the radius of the main body, preferably between 2% and 21%. According to another embodiment of the present invention, the vertexes can form a straight angle.

“Detail C” shows a cross section of the tube 200 of the apparatus according to the present invention, which has a first axis “z” and a second axis “k”. In this regard, the first axis is equal or greater than the second axis. Preferably, the first axis is between 50% to 99% of the value corresponding to the tube length (i.e., the distance between the first end 210 and the second end 220 of the tube 200), more preferably between 65% and 85%. More preferably, the second axis ‘k’ value is between 25% and 95% of the value corresponding to the distance between the main body first face 310 and second face 320.

From the process perspective, the apparatus' main function is to drive a larger amount of fluid, that enters a pelletizer chamber, against the interface between the die and the knives-holder front face. More fluid in this region tends to cool down the pellet, immediately after it is cut, in a quicker manner. Another advantage, just as important, is that the apparatus promotes a shorter fluid residence time in the cutting and rotational regions. Consequently, the pellets, driven by the fluid, leave these regions faster, thus, minimizing the probability of touching each other (and agglomerates generation). Additionally, the apparatus addresses clean water (without pellets) to the pellets cutting region once this water stream is collected from the pelletizer chamber inlet.

From the mechanical perspective, to use the apparatus it is not necessary to make substantial geometrical or design modifications to the current structure of the underwater pelletizer. The diffuser apparatus is a customized piece, and its dimensions are adapted to the underwater pelletizer characteristics.

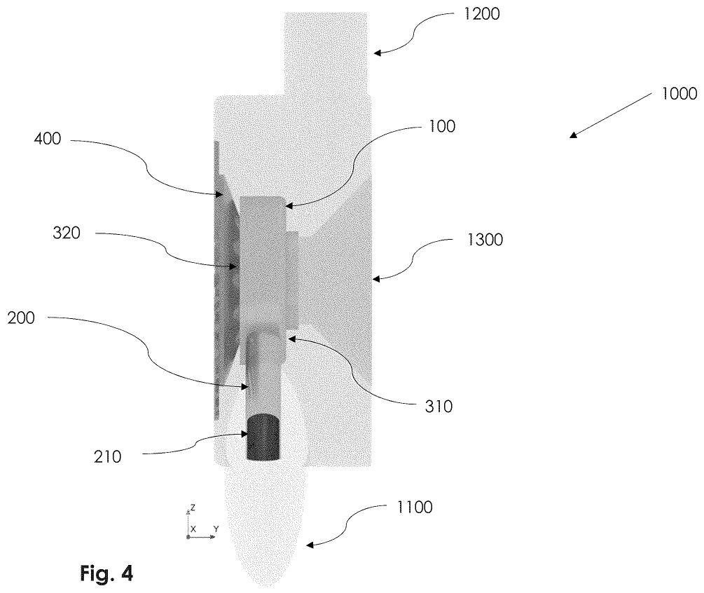

Referring to FIG. 4, a schematic illustration of the system 1000 according to one or more embodiments of the present invention is depicted. Such system is conceived to improve hydrodynamics in an underwater pelletizer, the system 1000 comprising an apparatus 100 attached to an underwater pelletizer by means of a knives-holder shaft support 1300 of such pelletizer or, alternatively, to an internal wall of the pelletizer chamber (not depicted).

Such apparatus 100 comprises a tube 200 extending from a first end 210 to a second end along which a fluid flows, the first end being in fluid communication with a pelletizer chamber inlet 1100—fluid supply for the first end 210 of the tube 200—from which the fluid flows in direction to the second end 220, and a main body 300 in fluid communication with the second end 220. The system has a pelletizer chamber outlet 1200 as well, where the water/pellet mixture will be conveyed into a drying section, where the pellets will be separated from the water. The fluid/water is pumped back to the pelletizer chamber, in a close circuit.

The main body 300 has a first face 310 and a second face 320 parallel to the first face, spaced from each other by a lateral surface 330. The first face 310 is integral and opposite to a back side of the knives-holder 400 of such pelletizer and the second face 320 is hollow and facing the back side of the knives-holder 400, which optionally has at least a pumping hole. The main body 300 is designed to receive fluid from the second end 220 of the tube 200 and to deliver it towards the back side of the knives-holder 400 by the second face 320. The apparatus 100 is in fluid communication with the die, so that the fluid leaves said apparatus and continuously contacts said die during pellets formation.

According to one embodiment of the system of the present invention, the distance between the pelletizer chamber inlet 1100 and the first end 210 of the tube 200 is between 1% and 65% of the radius of the main body 300, preferably between 1% and 25%. According to another embodiment of the system of the present invention, the first end 210 of the tube 200 is inserted into the pelletizer chamber inlet 1100.

According to one embodiment of the system of the present invention, the first end 210 of the tube 200 is centralized within the pelletizer chamber inlet 1100.

Having explained the detailed aspects of the present invention, some advantageous data related to the apparatus and system according to the present invention will be discussed hereinafter.

Accordingly, three different apparatus designs were tested using Computational Fluid Dynamics (CFD) modelling (named as “Design 1”, “Design 2” and “Design 3”), under the same operating conditions (pressure, temperature, fluid density and dynamic viscosity, water flow rate at Pelletizer Chamber inlet, knives rotation rate and number of knives). In order to evaluate the performance of each apparatus design, the amount of fluid (specifically, water) passing through pumping holes and the water residence time within the cutting and rotational regions, including the apparatus internal volume, were defined as variables of interest.

For the three designs studied, some physical parameters were modified in order to understand their relevance and influence for the present solution. In this regard, the following parameters were modified:
the radius of the main body 300: for Design 1 the radius of the main body being less than, for Design 2 the radius of the main body being greater than and for Design 3 being equivalent to the distance from the center of the main body to the external radius of the pumping hole in the knives-holder;
the lateral surface 330 angle: for Design 1 and Design 2 the angle is less than 900 and for Design 3 the angle is 90° in relation to the first face 310;
the detail “B” diameter: for Design 1 and Design 3 the detail B diameter is less than 50 millimeters and for Design 2 such diameter is greater than 50 millimeters; and
the distance between the chamber inlet 1100 and the first end 210: for Design 2 the distance is greater than 0 centimeters, for Design 3 the distance is coincident with the chamber inlet 1100, and for Design 1 the tube 200 is partially inside of the chamber inlet (not exceeding 5 centimeters inside the chamber inlet).

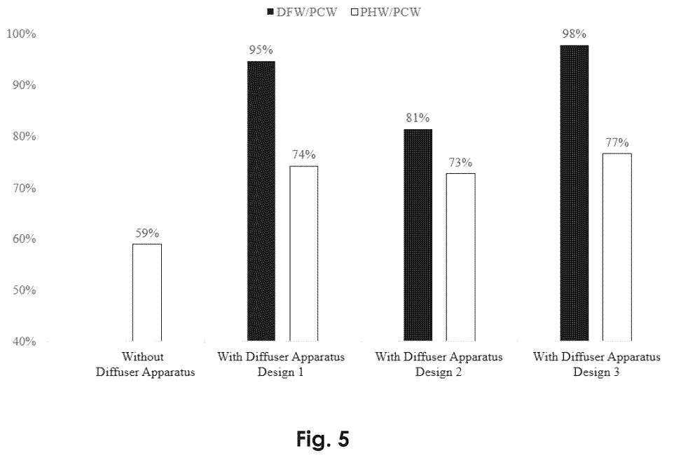

In this regard, FIG. 5 shows the amount of water coming from the pelletizer chamber inlet (PCW) that is captured by the apparatus (DFW/PCW), and the amount of water passing through the pumping holes (PHW/PCW).

Based on such modelling experiments, it is clear the benefit of using the apparatus, regardless its design, since the amount of water passing through the pumping holes (PHW/PCW) increases dramatically. By comparing the different apparatus designs tested with each other, it was proved that the design according to the present invention (named “Design 3”) is the best as it provides an 18% increase in the amount of water passing through the pumping holes (PHW/PCW), which is higher than the other designs.

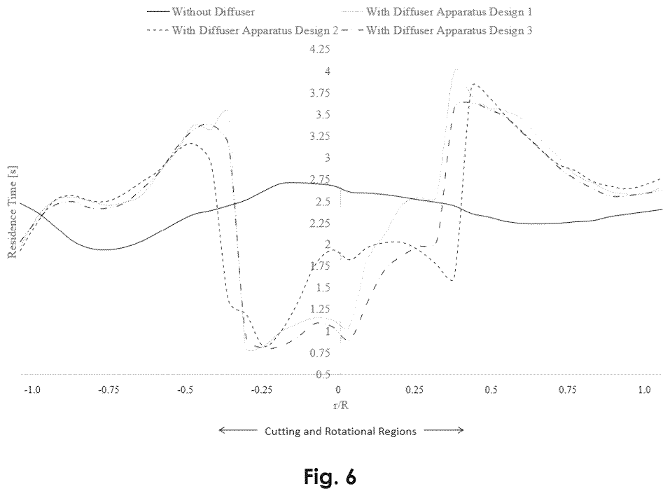

Referring to FIG. 6, the water residence time inside the pelletizer chamber and, especially, in the cutting and rotational regions were evaluated. In these regions the drop in the water residence time is evident, showing once again the advantage of using the apparatus according to the present invention. Comparing the designs, the embodiment according to the present invention (Design 3) was the one that showed the lowest residence time distribution among the tests using the Diffuser Apparatus, showing that the proposed apparatus is effective in driving the pellets and water faster out of these regions.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. An apparatus to improve the hydrodynamics in an underwater pelletizer, the apparatus being attachable to a knives-holder shaft support of the pelletizer or to an internal wall of the pelletizer chamber, the apparatus comprising:
a tube extending from a first end to a second end along which a fluid flows,
the first end being in fluid communication with a fluid supply from which the fluid flows in a direction from the first end to the second end, and
a main body in fluid communication with the second end,
the main body having a first face and a second face parallel to the first face, spaced from each other by a lateral surface,
the first face being integral and opposite to a die of the pelletizer, and the second face being hollow and facing a back side of the knives-holder;
wherein the main body is designed to receive fluid from the second end of the tube and to deliver it towards the back side of the knives-holder by the second face.

2. The apparatus according to claim 1, wherein the tube has a cross section having a first axis “z” and a second axis “k”.

3. The apparatus according to claim 2, wherein the first axis “z” is equal to or greater than the second axis “k”.

4. The apparatus according to claim 2, wherein the first axis is between 50% to 99% of the value corresponding to the tube length.

5. The apparatus according to claim 1, wherein the tube has at least one lateral surface tangential to the lateral surface of the main body.

6. The apparatus according to claim 1, wherein the main body is cylindrical.

7. The apparatus according to claim 6, wherein vertexes of the cylindrical main body are round-shaped.

8. The apparatus according to claim 7, wherein the radius of the round-shaped vertexes is less than 45% of the radius of the main body.

9. The apparatus according to claim 1, wherein the apparatus is attached to the knives-holder shaft support or to an internal wall of the pelletizer chamber, by means of at least one selected from screws, flanges, clips, and combinations thereof.

10. The apparatus, according to claim 1, wherein the main body is designed to receive fluid from the second end of the tube and flow the fluid in the same direction as a direction the knives-holder runs.

11. A system for improving hydrodynamics in an underwater pelletizer, the system comprising an apparatus attached to an underwater pelletizer by means of a knives-holder shaft support of such pelletizer or to an internal wall of the pelletizer chamber, said apparatus comprising:
a tube extending from a first end to a second end along which a fluid flows,
the first end being in fluid communication with a pelletizer chamber inlet from which the fluid flows in a direction from the first end to the second end, and
a main body in fluid communication with the second end,
the main body having a first face and a second face parallel to the first face, spaced from each other by a lateral surface,
the first face being integral and opposite to a back side of the knives-holder of such pelletizer, the knives holder optionally having at least a pumping hole;
and the second face being hollow and facing the back side of the knives-holder;
the main body being designed to receive fluid from the second end of the tube and to deliver it towards the back side of the knives-holder by the second face;
wherein the apparatus is in fluid communication with the die, so that the fluid leaves said apparatus and continuously contacts said die during pellets formation.

12. The system according to claim 11, wherein the distance between the pelletizer chamber inlet and the first end of the tube is between 1% and 65% of the radius of the main body.

13. The system according to claim 11, wherein the first end of the tube is centralized within the pelletizer chamber inlet.

14. The system according to claim 11, wherein the fluid enters tangentially in the main body and flows within the main body in the same direction as a direction the knives-holder runs, in a Reynolds number range from 1.0E+06 to 9E+07.

15. The system according to claim 11, wherein the apparatus and the knives-holder back face are separated by a horizontal distance “x” and the main body's outer radius and the knives-holder back face are separated by a vertical distance “y”.

16. The system according to claim 15, wherein the horizontal distance (x) is less than 45% of the radius of the main body.

17. The system according to claim 15, wherein the vertical distance (y) satisfies the relationship:
t−w≤y≤u
wherein “t” is a distance the center of knives-holder and the center of the pumping hole, “w” is a radius of the pumping role cross-section, and “u” is a radius of the knives-holder.

18. The system according to claim 17, wherein the vertical distance (y) is equal to the radius of the knives-holder.

19. The system according to claim 11, wherein the external radius of the main body is equal to or greater than external radius of the knives-holder.
